(19) United States
(12) Patent Application Publication
(10) Pub. No.: US 2017/0227093 A1
(43) Pub. Date: Aug. 10, 2017

(54) PLANETARY GEAR UNIT

(71) Applicant: TOYOTA JIDOSHA KABUSHIKI KAISHA, Toyota-shi (JP)

(72) Inventors: Morihiro MATSUMOTO, Susono-shi (JP); Fusahiro TSUKANO, Susono-shi (JP)

(73) Assignee: TOYOTA JIDOSHA KABUSHIKI KAISHA, Toyota-shi (JP)

(21) Appl. No.: 15/397,095

(22) Filed: Jan. 3, 2017

(30) Foreign Application Priority Data
Feb. 9, 2016 (JP) 2016-022559

(51) Int. Cl. F16H 1/28; F16H 57/12

(52) U.S. Cl. CPC F16H 1/2863; F16H 57/12; F16H 2057/127

(57) ABSTRACT

The planetary gear unit in which sliding resistance between a double helical gear and a peripheral member is reduced is provided. The planetary gear unit comprises: pinion gears individually having two rows of oppositely-oriented helical gears in an axial direction; a first pushing member that elastically pushes at least one of the pinion gears toward in a predetermined axial direction; and a second pushing member that elastically pushes at least one of the remaining pinion gears in the opposite axial direction.

### CROSS REFERENCE TO RELATED APPLICATION

The present invention claims the benefit of Japanese Patent Application No. 2016-022559 filed on Feb. 9, 2016 with the Japanese Patent Office, the disclosures of which are incorporated herein by reference in its entirety.

### BACKGROUND

Field of the Invention

The present application relates to a planetary gear unit including pinion gears having a double helical gear.

Discussion of the Related Art

In gear transmission devices used in vehicles, to allow a pair of meshed gears to be smoothly and reasonably rotated, a play or a backlash has to be maintained between tooth surfaces of the gears. However, in a gear train that transmits power from a prime mover such as an engine to an object to be driven, the tooth surfaces of the gears meshed with each other may collide with each other due to pulsation of the engine torque to generate noise and vibration.

In a conventional backlash preventing device taught e.g., by JP-U-50-83472, a double helical gear is fixed to one of a driving shaft and a driven shaft arranged in parallel, a pair of helical gears is attached to the other shaft while being respectively meshed with teeth inclined in reverse directions to each other in the double helical gear, and a spring stretched between the pair of helical gears to push the helical gears in an axial direction.

In the above-described backlash preventing device, the pair of helical gears biased in the axial direction to eliminate backlash is meshed with the double helical gear. However, in the above-described gear transmission backlash preventing device, the double helical gear is pressed in the axial direction by a tooth surface of the other helical gear spring-biased in the axial direction with respect to one helical gear. Therefore, a side surface of the double helical gear may come into contact to an adjacent peripheral member, and sliding resistance may occur.

### SUMMARY

The present application has been conceived noting the above-described technical problem, and it is therefore an object of the present application is to provide a planetary gear unit that can reduce sliding resistance between a side surface of a gear meshing with a double helical gear pushed to eliminate backlash and a peripheral member.

Embodiments of the present application relates to a planetary gear unit comprising a plurality of pinion gears, each of which has two rows of oppositely-oriented helical gears in an axial direction. In order to achieve the above-explained objective, according to the embodiments of the present application, the planetary gear unit is provided with a first pushing member that elastically pushes at least one of the pinion gears in a predetermined axial direction, and a second pushing member that elastically pushes at least one of the remaining pinion gears in the opposite axial direction.

In a non-limiting embodiment, positions of the first pushing member and the second pressing member to push the pinion gears, and number of pushing members may be determined in such a manner that pushing forces pushing the pinion gears cancel each other out.

In a non-limiting embodiment, pushing forces of the first pushing member and the second pushing member may be individually determined in such a manner that a total pushing force pushing said one of the pinion gear in the predetermined axial direction and a total pushing force pushing said one of the remaining pinion gears in the opposite axial direction cancel each other out.

In a non-limiting embodiment, the first pressing member and the second pressing member may include an elastic ring that applies an elastic force to a side face of the pinion gear thereby pushing the pinion gear in the axial direction.

Thus, according to the embodiments of the present application, the planetary gear unit is provided with the first pushing member that elastically pushes at least one of the pinion gears in the predetermined axial direction, and the second pushing member that elastically pushes at least one of the remaining pinion gears in the opposite axial direction. That is, the pushing force of the first pushing member and the pushing force of the second pushing member cancel each other out. According to the embodiments of the present application, therefore, an axial thrust applied e.g., to a sun gear or a ring gear meshed with the pinion gear can be reduced.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a schematic illustration showing a preferred embodiment of a planetary gear unit according to the present application;

FIG. 2 is a perspective view showing a part of the planetary gear unit shown in FIG. 1;

FIG. 3 is a cross-sectional view partially showing a cross-section of the planetary gear unit including a first pinion gear;

FIG. 4 is a cross-sectional view partially showing a cross-section of the planetary gear unit including a third pinion gear;

FIG. 5 is a cross-sectional view showing a cross-section a first spring ring;

FIG. 6 is an explanatory illustration showing elastic deformation of the spring ring;

FIG. 7 is a cross-sectional view showing a cross-section of the entire planetary gear unit;

FIG. 8 is a schematic illustration showing a planetary gear unit according to another embodiment in which an odd number of pinion gears are pushed by the spring rings;

FIG. 9 is a schematic illustration showing a planetary gear unit of still another embodiment in which some of the pinion gears are pushed by the spring rings and the remaining pinion gears are not pushed; and

FIG. 10 is an explanatory illustration showing a power train of a vehicle using the planetary gear unit according to the embodiment of the present application.

### DETAILED DESCRIPTION OF THE PREFERRED EMBODIMENT(S)

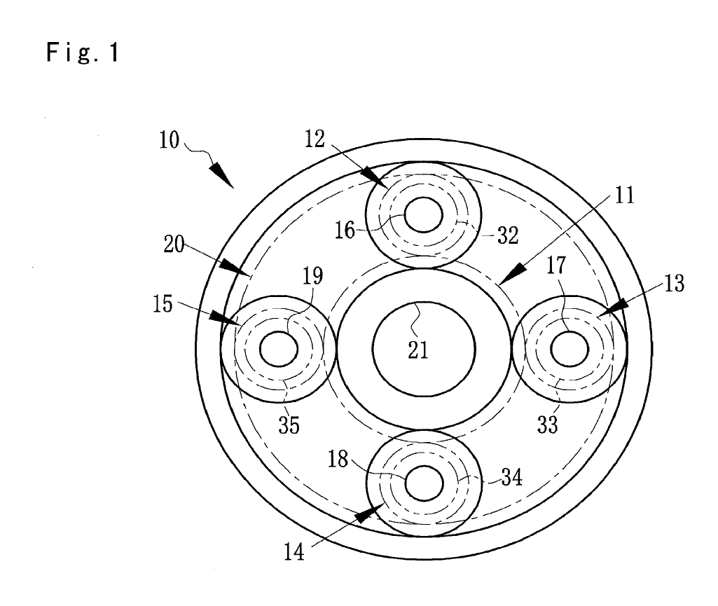

FIG. 1 is a schematic illustration showing a preferred embodiment of a planetary gear unit 10 according to the present application. As illustrated in FIG. 1, the planetary gear unit 10 is a single-pinion planetary gear unit including a sun gear 11, first to fourth pinion gears 12 to 15, first to fourth pinion shafts 16 to 19, and a ring gear 20. Each of the first pinion shafts 16 to 19 is individually connected to a carrier to support the first to fourth pinion gears 12 to 15 respectively. The ring gear 20 is arranged concentrically with the sun gear 11 fitted onto a rotary shaft 21. The first to fourth pinion gears 12 to 15 are arranged around the sun gear 11 at regular intervals while being meshed with the sun gear 11 and the ring gear 20.

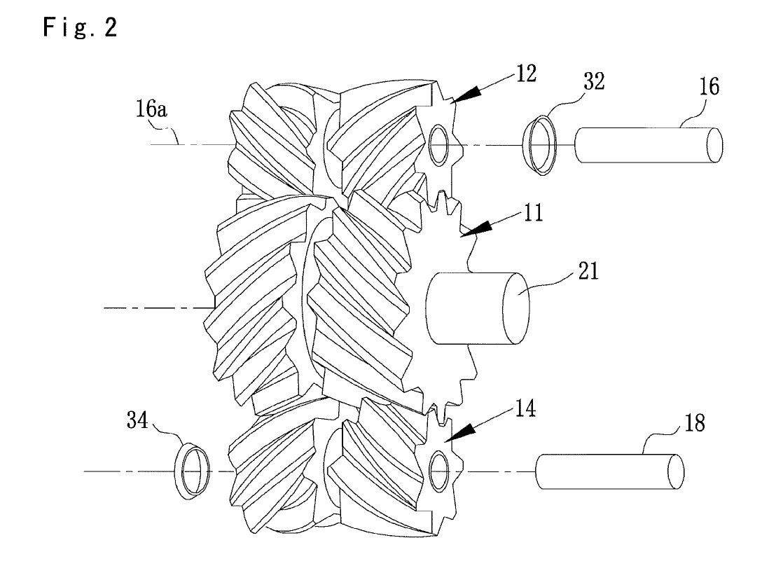

FIG. 2 is a perspective view showing part of the planetary gear unit 10 shown in FIG. 1. In FIG. 2, the ring gear 20, the second and fourth pinion gears 13 and 15 and so on are omitted for the sake of illustration. The first pinion gear 12 is a double helical gear having two sets of helical gears, and those helical gears are oppositely angled in an axial direction 16a. The third pinion gear 14 is also a double helical gear having two sets of oppositely angled helical gears. The sun gear 11 is also a double helical gear having two sets of oppositely angled helical gears meshed with the first pinion gear 12 and the third pinion gear 14. Note that, the second pinion gear 13, the fourth pinion gear 15, and the ring gear 20 are also double helical gears individually having two sets of oppositely angled helical gears.

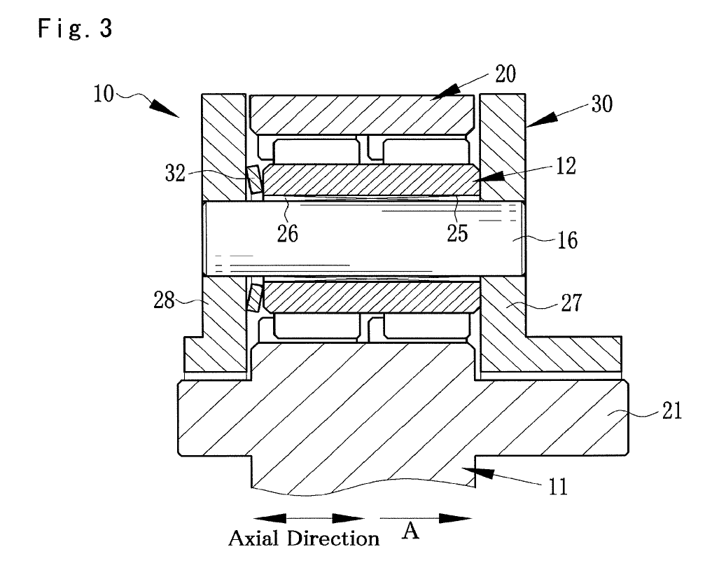

FIG. 3 is a cross-sectional view showing a cross-section of a part of the planetary gear unit 10 including the first pinion gear 12. As illustrated in FIG. 3, the first pinion gear 12 is provided with a first spring ring 32 that elastically pushes the first pinion gear 12 in a predetermined direction A of the axial direction of the rotary shaft 21. Note that the second pinion gear 13 has the same sectional shape as the shape illustrated in FIG. 3, and is provided with a second spring ring 33 (see FIG. 1) that elastically pushes the second pinion gear 13 in the direction A.

The first pinion shaft 16 is inserted into a center hole 25 of the first pinion gear 12. A bearing 26 as a needle roller is disposed between an outer circumferential face of the first pinion shaft 16 and an inner circumferential face of the central hole 25. The first pinion gear 12 is rotatably supported by the first pinion shaft 16 through the bearing 26. Both ends of the first pinion shaft 16 are supported by a pair of first and second side plates 27 and 28. The first side plate 27 and second side plate are allowed to rotate freely around the rotating shaft 21 while supporting both ends of the second to fourth pinion shafts 17 to 19. Thus, a carrier 30 comprises the pair of first and second side plates 27 and 28, and the first to fourth pinion shafts 16 to 19. The carrier 30 is rotated around the rotary shaft 21 by a rotational force associated with revolution of the first to fourth pinion gears 12 to 15.

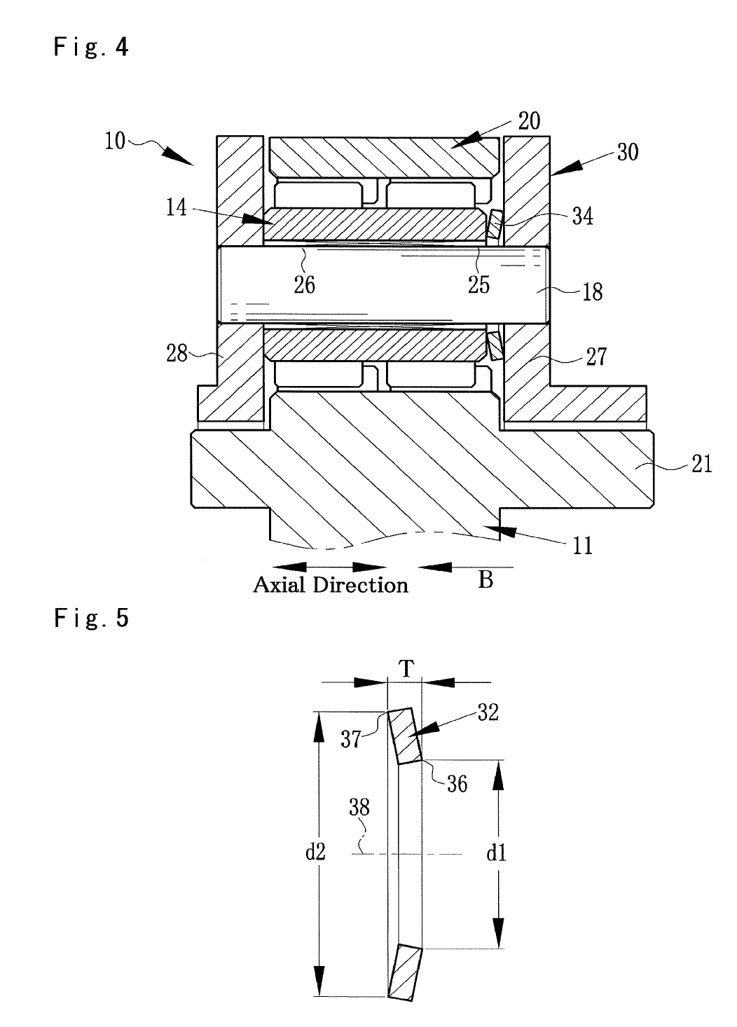

FIG. 4 is a cross-sectional view showing a part of the planetary gear unit 10 including the third pinion gear 14. As illustrated in FIG. 4, the third pinion gear 14 includes a third spring ring 34 that elastically pushes the third pinion gear 14 in the opposite direction B of the axial direction. Note that the fourth pinion gear 15 has the same sectional shape as the shape illustrated in FIG. 4, and includes a fourth spring ring 35 (see FIG. 1) that elastically pushes the fourth pinion gear 15 in the opposite direction B. Note that the first to fourth spring rings 32 to 35 have a function to eliminate play or backlash in the axial direction of the first to fourth pinion gears 12 to 15. Note that, in FIG. 4, members that are the same as or similar to those described in FIG. 3 are denoted with the same reference signs, and detailed description here is omitted.

FIG. 5 is a cross-sectional view showing a cross-section of the first spring ring 32. Note that the first to fourth spring rings 32 to 35 have the same shape and hence simply referred to as spring ring 32 hereinafter. The spring ring 32 includes an opening having an inner diameter d1 that is smaller than an outer diameter d2 of an outer circumference. A diametrically-inner portion of the first spring ring 32 is displaced from the outer circumference in the axial direction 16a (i.e., in a thickness direction T). Further, the spring ring 32 is made from elastic material so that the diametrically-inner portion thereof elastically deforms in the thickness direction T. In the planetary gear unit 10, therefore, only an opening edge 36 is brought into contact to one of side faces of the pinion gear 12, and only an outer edge 37 is brought into contact to the second side plate 28 of the carrier 30. For this reason, sliding resistance can be reduced not only between spring ring 32 and the side face of the pinion gear 12 but also between the spring ring 32 and the second side plate 28. The spring ring 32 may serve not only as the first pushing member but also as the second pushing member.

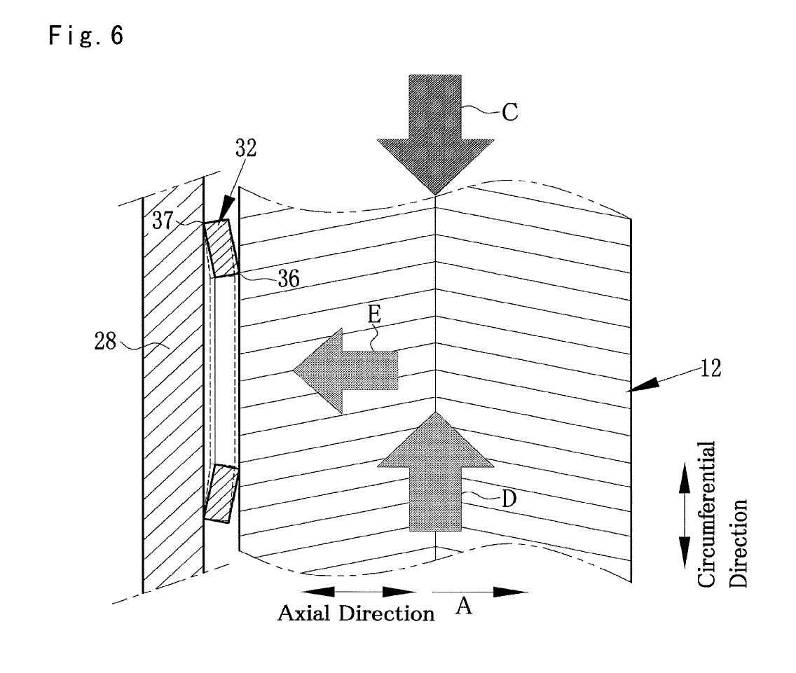

FIG. 6 is an explanatory illustration showing cross-sections of the double helical pinion gear 12, the second side plate 28, and spring ring 32 that is deformed elastically. As illustrated in FIG. 6, when the pinion gear 12 is rotated to transmit driving force D while being subjected to a load C from the ring gear 20 meshing therewith, the pinion gear 12 generates thrust force E in the axial direction. In this situation, the spring ring 32 is deformed elastically in the thickness direction T to absorb the thrust force E as indicated by the dashed lines, and then the thrust force E is damped by a rotation of the pinion gear 12 so that the spring ring 32 is restored to the original shape. Consequently, the pinion gear 12 is pushed by the spring ring 32 in the predetermined direction A.

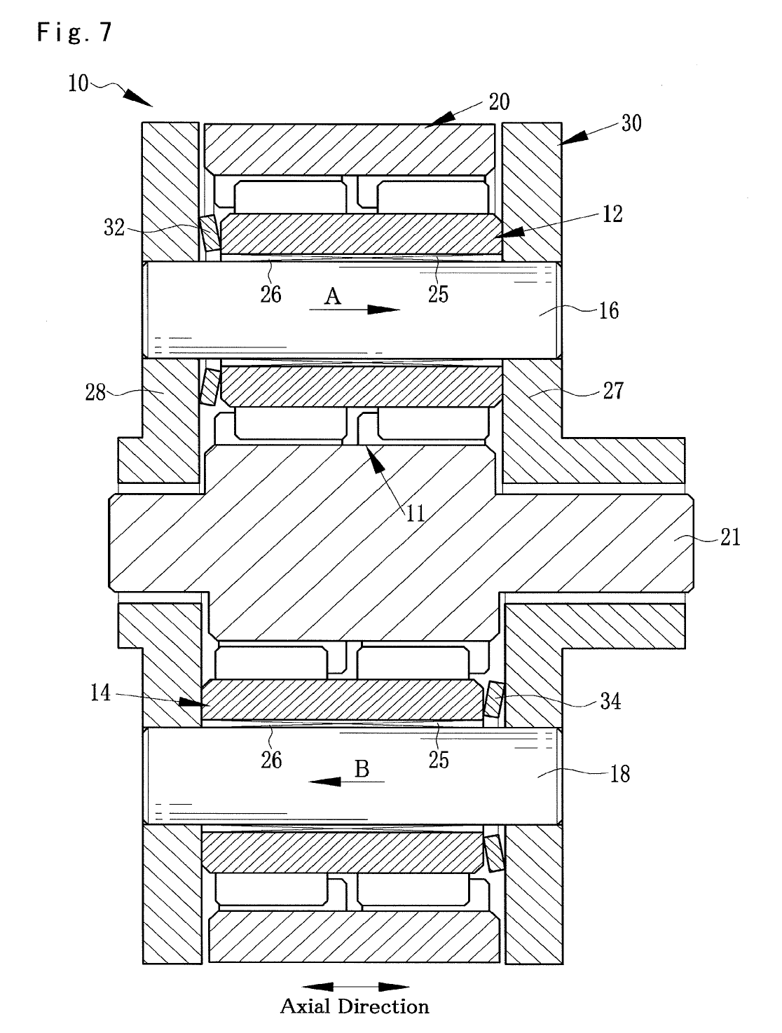

FIG. 7 is a cross-sectional view showing a cross-section of the entire planetary gear unit 10. As illustrated in FIG. 7, the first pinion gear 12 pushed by the first spring ring 32 toward the direction A and the third pinion gear 14 pushed by the third spring ring 34 toward the opposite direction B are disposed in symmetric positions across the rotary shaft 21. Given that the pushing force of the first spring ring 32 and the pushing force of the third spring ring 34 are identical to each other, the pushing force applied to the first pinion gear 12 in the predetermined direction A and the pushing force applied to the third pinion gear 14 in the opposite direction B cancel each other out. According to the preferred embodiment, therefore, the sun gear 11 meshing with the first pinion gear 12 and the ring gear 20 meshing with the third pinion gear 14 can be prevented from being subjected to a thrust force.

Although not especially illustrated in FIG. 7, the second pinion gear 13 pushed by the second spring ring 33 toward the predetermined direction A and the fourth pinion gear 15 pushed by the fourth spring ring 35 toward the opposite direction B are also disposed in symmetric positions across the rotary shaft 21 (c.f., FIG. 1). Given that the pushing force of the second spring ring 33 and the pushing force of the fourth spring ring 35 are identical to each other, the pushing force applied to the second pinion gear 13 in the direction A and the pushing force applied to the fourth pinion gear 15 in the opposite direction B cancel each other out. For this reason, the sun gear 11 and the ring gear 20 may also be prevented from being subjected to the thrust force applied from the second pinion gear 13 and the fourth pinion gear 15 meshing therewith. In the planetary gear unit 10, therefore, the sun gear 11 and the ring gear 20 can be prevented from being moved in the axial direction to be brought into contact to the first and second side plates 27 and 28. For this reason, frictional damage on the planetary gear unit 10 can be limited while ensuring power transmission efficiency. Here, it is to be noted that the pushing forces applied to the first pinion gear 12 and the second pinion gear 13 in the predetermined direction A and the pushing forces applied to the third pinion gear 14 and the fourth pinion gear 15 in the opposite direction B are not necessarily cancel each other out completely.

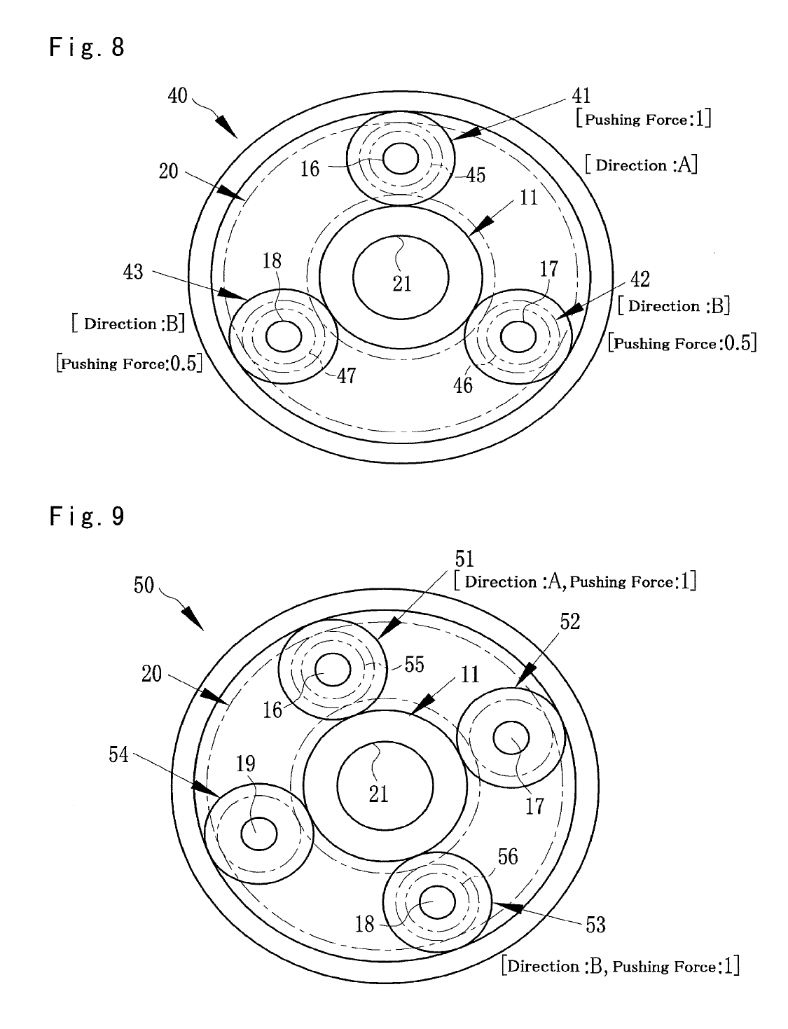

Thus, in the foregoing preferred embodiment, the planetary gear unit 10 is provided with the four pinion gears 12 to 15. However, according to the present application, the number of the pinion gears should not be limited to that of the preferred embodiment, and may be altered according to need. FIG. 8 is a schematic illustration showing a planetary gear unit 40 according to another embodiment in which an odd number of pinion gears 41 to 43 are arranged at regular interval around the rotary shaft 21 the sun gear 11. According to another embodiment, a first spring ring 45 is attached to one of the side faces of the first pinion gear 41 to apply a pushing force (indicated as “1” in FIG. 8) to the first pinion gear 41 in the predetermined direction A. Similarly, a second spring ring 46 is attached to one of the side faces of the second pinion gear 42 (opposite to said one of the side face of the first pinion gear 41) to apply a fifty percent of pushing force (indicated as “0.5” in FIG. 8) of the first spring ring 45 to the second pinion gear 42 in the opposite direction B. Likewise, a third spring ring 47 is attached to one of the side faces of the third pinion gear 43 (opposite to said one of the side face of the first pinion gear 41) to apply a fifty percent of pushing force (indicated as “0.5” in FIG. 8) of the first spring ring 45 to the third pinion gear 43 in the opposite direction B. Thus, the pushing force pushing the first pinion gear 41 in the predetermined direction A and a total pushing force pushing the second pinion gear 42 and the third pinion gear 43 may cancel each other out by adjusting pushing forces of the spring rings even if odd number of the pinion gears are used in the planetary gear unit. Note that, in FIG. 8, the members in common with those shown in FIGS. 1 and 7 are denoted with the same reference signs, and detailed description of those members will be omitted.

The forgoing embodiments have been explained based on the premise that pinion gears are arranged at regular intervals around the sun gear. However, after fitting one of the pinion gears in between the sun gear and the ring gear while meshing with those gears, the remaining pinion gears may not be fitted in between the sun gear and the ring gear while maintaining regular intervals accurately. That is, after fitting one of the pinion gears in between the sun gear and the ring gear, positions of the teeth of the sun gear and the ring gear are fixed, and consequently the remaining pinion gears individually having the same number of teeth as the pinion gear already fitted in between the sun gear and the ring gear may by slightly displaced in the circumferential direction. According to the present application, therefore, definition of the expression “at regular intervals” includes such slight displacement of the pinion gears.

According to the foregoing embodiments, the spring rings are attached to all of the pinion gears of the planetary gear unit. However, according to the present application, the spring rings may also be attached only to some of the pinion gears. FIG. 9 is a schematic illustration showing a planetary gear unit 50 according to still another embodiment in which only some of the pinion gears are pushed by the spring rings. According to still another embodiment, the planetary gear unit 50 is also provided with first to fourth pinion gears 51 to 54. As illustrated in FIG. 9, the first spring ring 55 is attached to one of the side faces of the first pinion gear 51 to apply a pushing force to the first pinion gear 51 in the predetermined direction A. Likewise, the second spring ring 56 is attached to one of the side faces (opposite to said one of the side face of the first pinion gear 51) of the third pinion gear 53 situated at a symmetric position with respect to the first pinion gear 51 across the rotary shaft 21 to apply a pushing force to the third pinion gear 53 in the opposite direction B. The spring ring is not attached to the remaining second pinion gear 52 and fourth pinion gear 54. According to still another embodiment, pushing forces of the first spring ring 55 and the second spring ring 56 are substantially identical to each other. According to still another embodiment, therefore, the pushing force of the first spring ring 55 pushing the first pinion gear 51 and the pushing force of the second spring ring 56 pushing the third pinion gear 53 also cancel each other out. For this reason, the sun gear 11 and the ring gear 20 may also be prevented from being subjected to thrust force. Note that, in FIG. 9, the members in common with those shown in in FIGS. 1 and 7 are also denoted with the same reference signs, and detailed description of those members will be omitted.

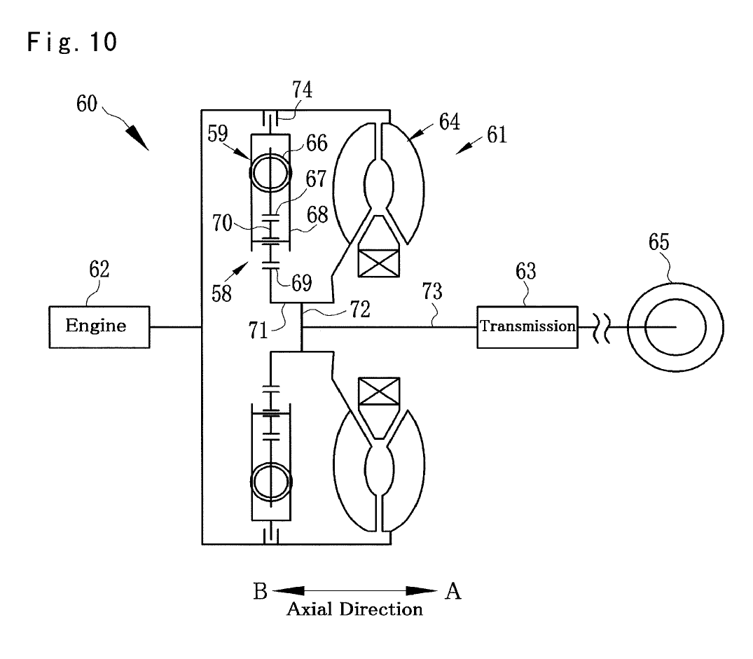

FIG. 10 is an explanatory illustration showing a power train 61 of a vehicle 60 using the planetary gear unit 58 according to the non-limiting embodiment of the present application. As illustrated in FIG. 10, a torque converter 64 is arranged between an engine 62 and a transmission 63 to suppress torsional vibrations resulting from pulsation of engine torque. A damper mechanism 59 including the planetary gear unit 58 is arranged inside the torque converter 64. The planetary gear unit 58 includes a ring gear 67 connected to the engine 62 through an elastic member 66, a carrier 68 connected to the engine 62, a sun gear 69 connected to the transmission 63, and the elastic member 66 disposed between the engine 62 and the ring gear 67. The carrier 68 supports a plurality of pinion gears 70 in a rotatable manner, and is connected to the engine 62 through a lock-up clutch 74.

At least one of the pinion gears 70 is elastically pushed by the first pushing member in the predetermined direction A, and at least one of the remaining pinion gears is elastically pushed by the second pressing member in the opposite direction B.

When the lock-up clutch 74 is in engagement, in the planetary gear unit 58, an engine torque is transmitted through a first route in which the engine torque is transmitted to the ring gear 67 through the elastic member 66, and a second route in which the engine torque is directly delivered to the carrier 68. The torques transmitted through the first route and the second route are synthesized at the sun gear 69 and further transmitted to the transmission 63 through a turbine hub 71, a turbine shaft 72, and an input shaft 73. The torque delivered to the transmission 63 is further transmitted to driving wheels 65 while being amplified by the transmission 63.

Since the first path includes a vibration system such as the elastic member 66, a phase shift may be caused between torsional vibrations resulting from pulsation of the engine torque transmitted through the first route and torsional vibrations resulting from pulsation of the engine torque transmitted through the second route. Specifically, in a frequency region below a resonance point (natural frequency) of the vibration system, the ring gear 67 and the carrier 68 vibrate with the same phase and hence the torsional vibrations synthesized in the planetary gear unit 58 may be amplified. By contrast, in a frequency region above the resonant point of the vibration system, the ring gear 67 and the carrier 68 vibrate at reverse phases, and hence the torsional vibration synthesized in the planetary gear unit 10 may be attenuated.

In conventional planetary gear units, when a torque delivered from a downstream side of the transmission (e.g., from driving wheels) exceeds the engine torque, teeth of gears meshing with each other may collide against each other to generate noise and vibrations. In order to avoid generation of such noise and vibrations, it is desirable to decrease backlash between teeth of the gears meshing with each other. In addition, it is further desirable to increase an meshing area between the gears to suppress noise. To this end, in the embodiment illustrated in FIG. 10, the planetary gear unit 10 using the double helical gears is used as the planetary gear unit 58. According to the embodiment illustrated in FIG. 10, therefore, the backlash existing between the sun gear 69 and the pinion gear 70 and between the ring gear 67 and the pinion gear 70 can be reduced while reducing sliding resistance of side surfaces of the sun gear 69 and the ring gear 67. For this reason, the noise and the vibration occurring from the planetary gear unit 58 can be reduced.

Further, the planetary gear unit according to the embodiment of the present application may be used as a power distribution device of a hybrid vehicle. In the power distribution device used in the hybrid vehicle, a rotary element connected to the engine serves as a first rotary element, a rotary element connected to a first motor serves as a second rotary element, and a rotary element connected to an output shaft serves as a third rotary element. The planetary gear unit further includes, a plurality of engagement devices such as a clutch and a brake, and a driving mode can by changed by manipulating the engagement devices. For example, the driving mode can be selected from a mode in which an engine torque is distributed to the output shaft and the first motor serving as a generator, and a mode in which the engine is disconnected from the power distribution device and an output torque of the first motor serving as a motor is applied to the output shaft. Note that each of the first to third rotating elements includes any one of the sun gear, the ring gear, and the carrier.

In the conventional power distribution device of a hybrid vehicle, noise and vibration may occur when the first motor is switched from a generator to a motor, when a rotating direction of the first motor is reversed, or when driving torque is changed. However, by thus using the planetary gear unit according to the embodiment of the present application as the power distribution device of the hybrid vehicle, noise and vibrations caused by a backlash reduction between the gears meshing with each other can be suppressed while sliding resistance of side surfaces of the sun gear meshing with the pinion gear.

Although the above exemplary embodiments of the present application have been described, it will be understood by those skilled in the art that the present application should not be limited to the described exemplary embodiments, and various changes and modifications can be made within the spirit and scope of the present application. For example, the double-helical gears used as the pinion gear may also be formed by combining a pair of helical gears for the sake of assemble work.

In addition, an elastic ring formed of resin material or rubber material may also be used as the spring ring to reduce friction. Optionally, the edge of the spring ring may be rounded. Further, the spring ring may also be shaped into an elliptical shape or an oval shape instead of true-circular shape. Furthermore, the spring ring may also be shaped into a wavy ring or C-shape.

What is claimed is:

1. A planetary gear unit, comprising:
a plurality of pinion gears, each of which has two rows of oppositely-oriented helical gears in an axial direction;
a first pushing member that elastically pushes at least one of the pinion gears in a predetermined axial direction; and
a second pushing member that elastically pushes at least one of the remaining pinion gears in the opposite axial direction.

2. The planetary gear unit according to claim 1, wherein positions of the first pushing member and the second pressing member to push the pinion gears, and number of pushing members are determined in such a manner that pushing forces pushing the pinion gears cancel each other out.

3. The planetary gear unit according to claim 1, wherein pushing forces of the first pushing member and the second pushing member are individually determined in such a manner that a total pushing force pushing said one of the pinion gears in the predetermined axial direction and a total pushing force pushing said one of the remaining pinion gears in the opposite axial direction cancel each other out.

4. The planetary gear unit according to claim 1, wherein the first pressing member and the second pressing member include an elastic ring that applies an elastic force to a side face of the pinion gear thereby pushing the pinion gear in the axial direction.

5. The planetary gear unit as claimed in claim 2, wherein pushing forces of the first pushing member and the second pushing member are individually determined in such a manner that a total pushing force pushing said one of the pinion gear in the predetermined axial direction and a total pushing force pushing said one of the remaining pinion gears in the opposite axial direction cancel each other out.

6. The planetary gear unit according to claim 2, wherein the first pressing member and the second pressing member include an elastic ring that applies an elastic force to a side face of the pinion gear thereby pushing the pinion gear in the axial direction.

7. The planetary gear unit according to claim 3, wherein the first pressing member and the second pressing member include an elastic ring that applies an elastic force to a side face of the pinion gear thereby pushing the pinion gear in the axial direction.

8. The planetary gear unit according to claim 5, wherein the first pressing member and the second pressing member include an elastic ring that applies an elastic force to a side face of the pinion gear thereby pushing the pinion gear in the axial direction.
